(19) United States
(12) Patent Application Publication
(10) Pub. No.: US 2013/0316395 A1
(43) Pub. Date: Nov. 28, 2013

(54) OPTICAL PARTICLE DETECTING DEVICE AND PARTICLE DETECTING METHOD

(71) Applicant: Azbil Corporation, Tokyo (JP)

(72) Inventor: Seiichiro KINUGASA, Tokyo (JP)

(73) Assignee: Azbil Corporation, Tokyo (JP)

(21) Appl. No.: 13/902,625

(22) Filed: May 24, 2013

(30) Foreign Application Priority Data
May 25, 2012 (JP) 2012-119478

(51) Int. Cl. G01N 21/53; G01N 21/64

(52) U.S. Cl. CPC G01N 21/53; G01N 21/64
USPC 435/34; 356/337; 356/338; 250/458.1; 250/459.1; 435/288.7; 250/227.11

(57) ABSTRACT

An optical particle detecting device includes a light source that emits light, an optical fiber that carries the emitted light, an emission-side condensing lens that condenses the light emitted from an end portion of the optical fiber, and a jet mechanism that causes an airstream including a particle to cut across the beam condensed by the emission-side condensing lens.

### CROSS REFERENCE TO RELATED APPLICATION

The present application claims priority under 35 U.S.C. §119 to Japanese Patent Application No. 2012-119478, filed May 25, 2012, which is incorporated herein by reference.

### FIELD OF TECHNOLOGY

The present invention relates to an environment evaluating technology, and, in particular, relates to an optical particle detecting device and particle detecting method.

### BACKGROUND

In clean rooms, such as bio clean rooms, airborne particles are detected and recorded using particle detecting devices. See, for example, Norio Hasegawa, et al., Instantaneous Bioaerosol Detection Technology and Its Application, Yamatake Corporation, Azbil Technical Review, December 2009, Pages 2-7, 2009. Optical particle detecting devices draw in air from a clean room, for example, and illuminate the drawn-in air with light. When there is a particle included within the air, the light is scattered by the particle, enabling detection of the densities, sizes, and the like, of any particles included in the air.

In an optical particle detecting device, the service life of the light source that emits the light tends to be shorter than the service lives of the other components. Because of this, sometimes there is the need for maintenance in order to replace the light source. However, when the light source is replaced sometimes this requires complex maintenance of the optics system, including lenses, and the like, as well. Given this, an aspect of the present invention is to provide an optical particle detecting device and particle detecting method wherein maintenance is easy.

### SUMMARY

An example of the present invention provides an optical particle detecting device including a light source that emits light, an optical fiber that carries the light, an emission-side condensing lens that condenses the light that is emitted from an end portion of the optical fiber, a jet mechanism that causes an airstream that includes a particle to cut across the light that is condensed by the emission-side condensing lens.

Another example of the present invention provides an optical particle detecting method including the steps of emitting light from a light source, an optical fiber carrying the light, condensing the light emitted from an end portion of the optical fiber, and an airstream including a particle cutting across the condensed light.

The present invention enables the provision of an easily-maintained optical particle detecting device and particle detecting method.

### BRIEF DESCRIPTION OF THE DRAWINGS

FIG. 1 is a schematic diagram of an optical particle detecting device according to an example according to the present invention.

FIG. 2 is a top face view of a light source according to an example according to the present invention.

FIG. 3 is a cross-sectional diagram, viewed from the direction of the section III-III shown in FIG. 2, of the light source as set forth an example according to the present invention.

FIG. 4 is a schematic diagram illustrating a method for capturing an image of a light source as set forth in an example according to the present invention.

FIG. 5 is a graph illustrating an intensity distribution of a light source according to an example according to the present invention.

FIG. 6 is a schematic diagram illustrating a pattern of light emitted from a light source being weakened by an optical fiber according to an example according to the present invention.

FIG. 7 is a first graph illustrating a distribution of optical flux of the light that is emitted by the particles in an example according to the present invention.

FIG. 8 is a second graph illustrating a distribution of optical flux of the light that is emitted by the particles in an example according to the present invention.

FIG. 9 is a third graph illustrating a distribution of optical flux of the light that is emitted by the particles in an example according to the present invention.

FIG. 10 is a fourth graph illustrating a distribution of optical flux of the light that is emitted by the particles in an example according to the present invention.

FIG. 11 is a schematic diagram of an optical particle detecting device according to another example according to the present invention.

### DETAILED DESCRIPTION

An example of the present invention will be described below. In the descriptions of the drawings below, identical or similar components are indicated by identical or similar codes. Note that the diagrams are schematic. Consequently, specific measurements should be evaluated in light of the descriptions below. Furthermore, even within these drawings there may, of course, be portions having differing dimensional relationships and proportions.

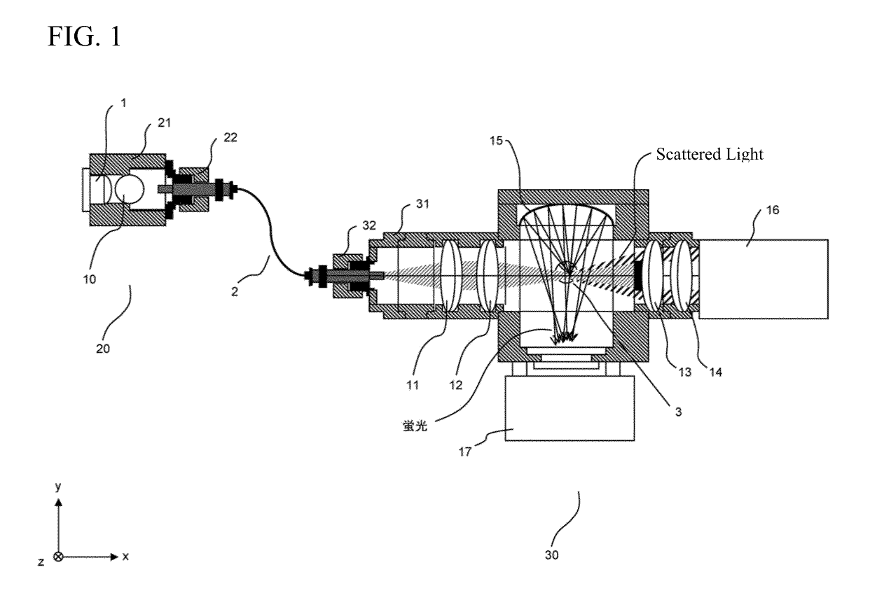

The optical particle detecting device according to the present example, as illustrated in FIG. 1, includes a light source 1 for emitting light, an optical fiber 2 for carrying the light, an emission-side condensing lens for condensing the light that is emitted from the emitting end portion of the optical fiber 2, and a jet mechanism 3 for causing an airstream, which includes particles, to cut across the light that has been condensed by the emission-side condensing lens 12. Here particles include microbes, non-toxic or toxic chemical substances, and dust such as dirt, grime, etc.

The light source 1 is included in a light source device 20. The light source device 20 includes a light source condensing lens 10 for condensing, onto an incident end portion of the optical fiber 2, the light emitted from the light source 1, a case 21 for holding the light source 1 and the light source condensing lens 10, and an optical fiber connector 22 for securing the optical fiber 2 to the case 21. The optical fiber connector 22 has a ferrule into which the incident end portion of the optical fiber 2 is inserted. The incident end portion of the optical fiber 2 is positioned at the focal point of the light source condensing lens 10. Doing so causes the light that is emitted from the light source 1 to be incident into the optical fiber 2.

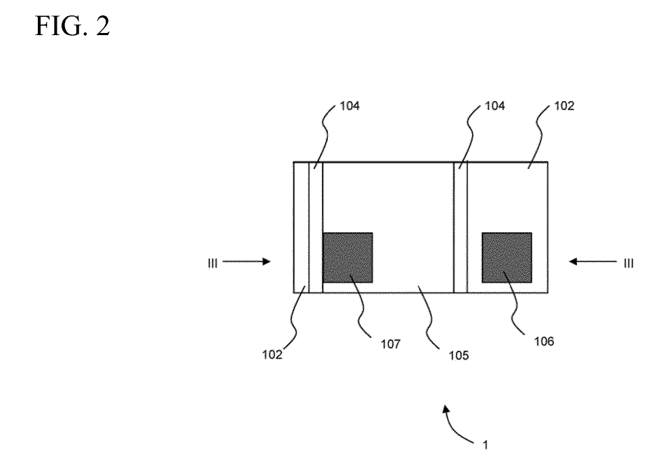

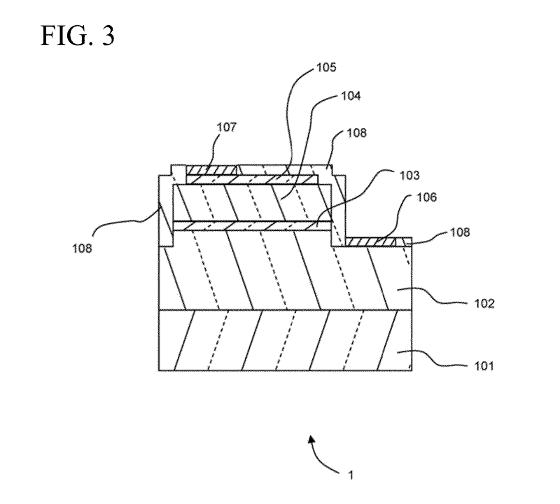

A light-emitting diode (LED), for example, may be used as the light source 1. The light source 1, as illustrated in FIG. 2, which is a top face view, and in FIG. 3, which is a cross-sectional diagram viewed along the section III-III, is provided with a substrate 101, a n-nitride semiconductor layer 102 disposed on top of the substrate 101, a light-emitting layer 103 disposed on top of the n-nitride semiconductor layer 102, a p-nitride semiconductor layer 104 disposed on top of the light-emitting layer 103, and a transparent electrode 105 disposed on top of the p-nitride semiconductor layer 104. A transparent p-side pad electrode 107 is disposed on top of the transparent electrode 105. An n-side pad electrode 106 is disposed on top of the n-nitride semiconductor layer 102. The n-nitride semiconductor layer 102, the p-nitride semiconductor layer 104, and the transparent electrode 105 are covered by a protective film 108. Note that the structure of the light source 1 is not limited thereto.

The light that is emitted from the light source 1 may be visible light or may be ultraviolet light. In the case of the light being visible light, the wavelength of the light is in the range of for example, between 400 and 410 nm, for example, 405 nm. In the case of the light being ultraviolet light, the wavelength of the light is in the range of, for example, between 310 and 380 nm, for example, 355 nm.

The emission-side condensing lens 12 and the jet mechanism 3 illustrated in FIG. 1 are included within a case 31 of the detecting device 30. The case 31 is provided with an optical fiber connector 32 for securing the optical fiber 2. The optical fiber 32 has a ferrule into which the emission end portion of the optical fiber 2 is inserted. The detecting device 30 is further provided with an emission-side collimating lens 11 for making the light that is emitted from the emission end portion of the optical fiber 2 into a collimated beam. The emission-side condensing lens 12 condenses the light that has been formed into a collimated beam by the emission-side collimating lens 11.

The jet mechanism 3 draws in air from the outside of the case 31, using a fan, or the like, and then emits a jet of the air that has been drawn in in the direction of the focal point of the emission-side condensing lens 12. The direction in which the airstream that is jetted from the jet mechanism 3, relative to the direction of propagation of the light condensed by the emission-side condensing lens 12 is set to, for example, essentially perpendicular. If a particle is included in the air here, then the light that strikes the particle is scattered, producing scattered light. When microorganisms, such as microbes, or the like, exist within the air, then the tryptophan, nicotinamide adenine dinucleotide, and riboflavin, and the like within the microbes that are exposed to the light produce fluorescence.

Examples of such microbes include Gram-negative bacteria, Gram-positive bacteria, and fungi such as mold spores. Escherichia coli, for example, can be listed as an example of a Gram-negative bacterium. Staphylococcus epidermidis, Bacillus atrophaeus, Micrococcus lylae, and Corynebacterium afermentans can be listed as examples of Gram-positive bacteria. Aspergillus niger can be listed as an example of a fungus such as a mold spore. The airstream the cuts across the light that is condensed by the emission-side condensing lens 12 is exhausted to the outside of the case 31 by an exhausting mechanism.

The detecting device 30 further includes a detecting-side collimating lens 13 for forming into a collimated beam the light that was cut-across by the airstream jetted by the jet mechanism 3, and a detecting-side condensing lens 14 for condensing the beam that was collimated by the detecting-side collimating lens 13. When scattered light is produced through a particle included in the airstream, the scattered light is also collimated by the detecting-side collimating lens, and thereafter is condensed by the detecting-side condensing lens 14.

A scattered light detecting portion 16 for detecting light scattered by particles is disposed at the focal point of the detecting-side condensing lens 14. The scattered light detecting portion 16 may use, for example, a photodiode, a photoelectron multiplier tube, or the like. The strength of the light that is scattered by a particle is correlated with the size of the particle. Consequently, detecting the intensity of the scattered light using the scattered light detecting portion 16 makes it possible to calculate the size of the airborne particles in the environment wherein the optical particle detecting device is placed.

A condensing mirror 15, which is a concave mirror, is also placed within the case 31 of the detecting device 30 in parallel with the airstream that is jetted from the jet mechanism 3. The condensing mirror 15 condenses the florescent light that is emitted from particles included within the airstream. A florescent light detecting portion 17, for detecting the florescent light, is disposed at the focal point of the condensing mirror 15. When scattered light is detected by the scattered light detecting portion 16 and no florescent light is detected by the florescent light detecting portion 17, then it is understood that the particle included within the airstream is a non-microbe particle. When scattered light is detected by the scattered light detecting portion 16 and florescent light is detected by the florescent light detecting portion 17 as well, then it is understood that the particle included in the airstream is a microbe particle. A computer for performing statistical processes on the light intensities and florescent light intensities that are detected is connected to the scattered light detecting portion 16 and the florescent light detecting portion 17.

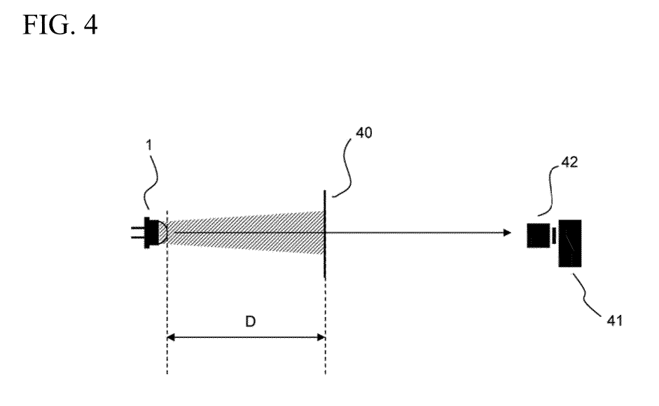

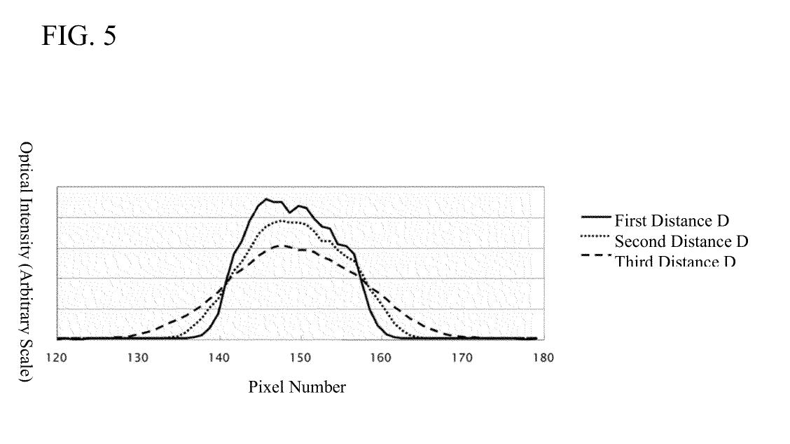

Here the non-transparent p-side pad electrode 107 that is disposed on top of the light-emitting layer 103 of the light source 1, illustrated in FIG. 2 and FIG. 3, causes non-uniform brightness of the light source 1. For example, as illustrated in FIG. 4, when an image of the light source 1 is formed directly on a screen 40, an image of the p-side pad electrode 107, illustrated in FIG. 2 and FIG. 3, is formed as well. Given this, the telephoto lens 42, illustrated in FIG. 4, was used to adjust so that the light pattern image on the screen 40 is formed onto an imaging element within an imaging camera 41, to capture, using the imaging camera 41, the image of the light source 1 that was formed on the screen 40. At this time, the distance D between the light source 1 and the screen 40 was varied to a first distance, a second distance that is longer than the first distance, and a third distance that is longer than the second distance. The result was that the optical intensities of the light patterns that were imaged were not distributed symmetrically around the centers, as illustrated in FIG. 5.

The sizes and shapes of the p-side pad electrodes 107, illustrated in FIG. 2 in FIG. 3, and the bonding wires that are connected to the p-side pad electrodes 107, vary by product. Moreover, even given the same product, they may vary from lot to lot. Moreover, depending on the way in which the light source 1 is secured, the direction of the p-side pad electrode 107 and of the bonding wire may also vary. Because of this, when an optics system that is unable to weaken the image of the p-side pad electrode 107 and of the bonding wire is used in the particle detecting device, then when the light source 1 is replaced during maintenance, the light that is emitted toward the particles may change non-uniformly, which may cause a change in the particle detection results as well.

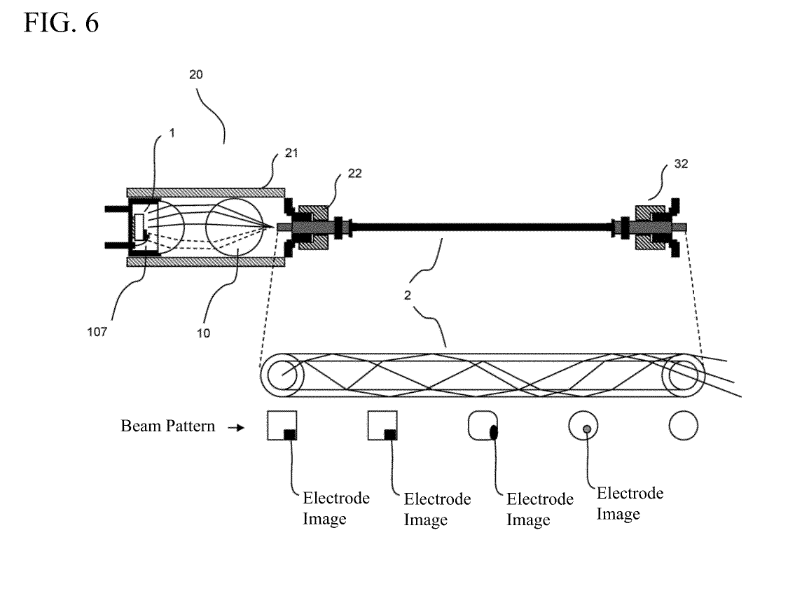

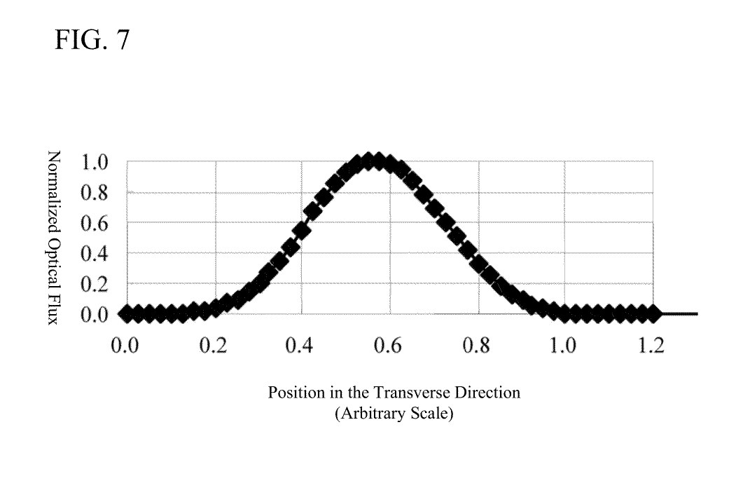

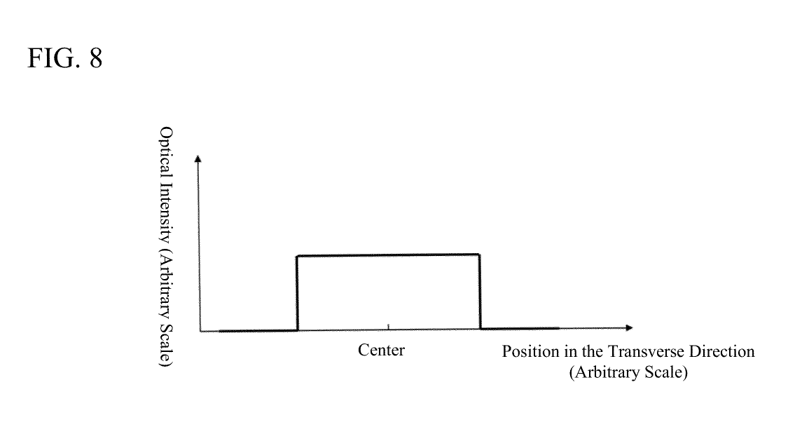

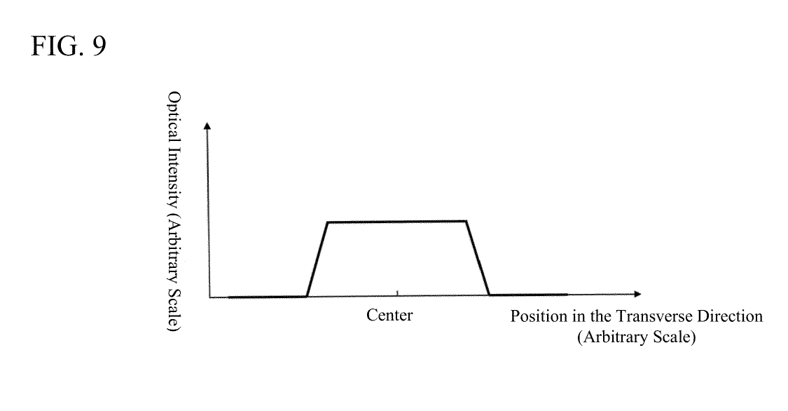

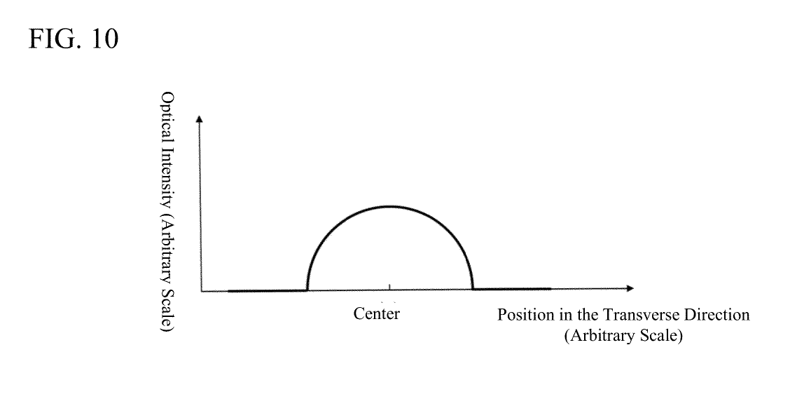

In response to this, the optical particle detecting device according to the present example is able to weaken the image of the p-side pad electrode 107 and of the bonding wire through the optical fiber 2 illustrated in FIG. 1. That is, as illustrated in FIG. 6, the beam pattern in the cross section of the beam directly after incidence into the optical fiber 2 includes a shadow that is the image of the p-side pad electrode 107. However, as the light advances within the optical fiber 2, the light is repeatedly reflected at the interface between the core and the clad of the optical fiber 2, causing the beam pattern to overlay itself from multiple angles, weakening the image of the p-side pad electrode 170 that is included within the beam pattern. Given this, the beam pattern for the light that is emitted from the emitting end portion of the optical fiber 2 is essentially circular, depending on the cross-sectional shape of the core of the optical fiber. Moreover, the optical flux in the cross-section of the beam, as illustrated in FIG. 7, is distributed essentially symmetrically about the center. Here the center is, for example, coincident with the optical axis of the optics system of the optical particle detecting device. As a distribution that is symmetrical about the center there is, for example, the normal distribution as illustrated in FIG. 7, the rectangular distribution as illustrated in FIG. 8, the trapezoidal distribution as illustrated in FIG. 9, the hemispherical distribution as illustrated in FIG. 10, and the like, although there is no limitation to being one of these.

A single-mode optical fiber or a multimode optical fiber may be used for the optical fiber 2. When compared to the single-mode optical fiber the multimode optical fiber more effectively tends to have an optical flux distribution that is symmetrical about the center in a cross-section of the beam pattern. Moreover, when the cross-sectional shape of the core of the optical fiber 2 is symmetrical about the axis, there will be a tendency for the optical flux distribution in a cross-section of the beam pattern to effectively be symmetrical about the center. The core diameter in the optical fiber 2 is set as appropriate depending on the size of the region cut across by the airstream that includes the particles.

Although the length of the optical fiber 2 is arbitrary, if it is too short the image of the p-side pad electrode 107 may remain in the emitted beam. Consequently, the length of the optical fiber 2 is set so as to weaken and eliminate the image of the p-side pad electrode 107 in the beam that is emitted from the emission end portion of the optical fiber 2. Conversely, the length of the optical fiber 2 may be set so that the optical flux distribution in a cross-section of the beam that is emitted from the end portion of the optical fiber 2 is symmetrical about the center.

As described above, when an optics system that is unable to weaken the image of the p-side pad electrode 107 is used in the particle detecting device, then when the light source 1 is replaced during maintenance, the light that is emitted toward the particles may change non-uniformly, which may cause a change in the particle detection results as well. Because of this, when an optics system that is unable to weaken the image of the p-side pad electrode 107 is used in the particle detector, then it will be necessary to control changes in the particle detection results by adjusting the lens system after replacing the light source 1 during maintenance. However, the adjustment of the lens system is not easy, requiring the knowledge and technical skills of a specialist.

In contrast, in the optical particle detecting device according to the present example, the image of the p-side pad electrode 107 is weakened by the optical fiber 2, meaning that there is essentially no variance in the distribution, within the plane, of the intensity of the light that is emitted toward the particles. Because of this, it is possible to eliminate the time required for adjusting the emission-side collimating lens 11, the emission-side condensing lens 12, the detecting-side collimating lens 13, and the detecting-side condensing lens 14, even when the light source 1 is replaced.

### Other Examples

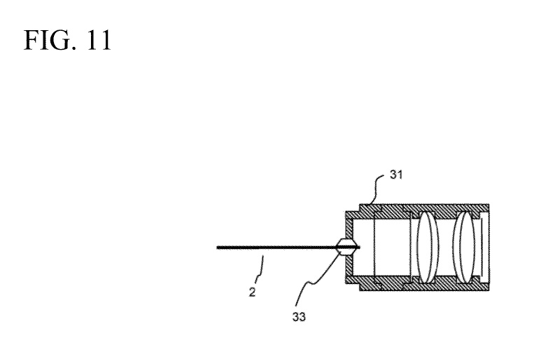

While there are descriptions of the example as set forth above, the descriptions and drawings that form a portion of the disclosure are not to be understood to limit the present invention. A variety of alternate examples and operating technologies should be obvious to those skilled in the art. For example, the method for securing the optical fiber into the case may be selected arbitrarily, where, as illustrated in FIG. 11, the optical fiber 2 may be secured to the case 31 by an adhesive 33. The end face of the optical fiber 2 may be polished. Moreover, while, in FIG. 1, a condensing mirror 15 that is a concave mirror is shown as a means for condensing the fluorescent light, the fluorescent light may instead be condensed through a combination of a spherical mirror and a lens. Conversely, an elliptical mirror may be provided with the airstream cutting across the beam at a first focal point of the elliptical mirror, with the fluorescent light detected at the second focal point. In this way, the present invention should be understood to include a variety of examples, and the like, not set forth herein.

1: An optical particle detecting device comprising:
a light source that emits light;
an optical fiber that carries the emitted light;
an emission-side condensing lens that condenses the light emitted from an end portion of the optical fiber; and
a jet mechanism that causes an airstream including a particle to cut across the beam condensed by the emission-side condensing lens.

2: The optical particle detecting device as set forth in claim 1, wherein the optical fiber is a multimode optical fiber.

3: The optical particle detecting device as set forth in claim 1, wherein the length of the optical fiber is set so that the optical flux in a cross-section of the beam that is emitted from the end portion of the optical fiber is distributed symmetrically about the center.

4: The optical particle detecting device as set forth in claim 3, wherein the optical flux in the cross-section of the beam that is emitted from the fiber end portion exhibits a normal distribution.

5: The optical particle detecting device as set forth in claim 3, wherein the optical flux in the cross-section of the beam that is emitted from the fiber end portion exhibits a rectangular distribution.

6: The optical particle detecting device as set forth in claim 3, wherein the optical flux in the cross-section of the beam that is emitted from the fiber end portion exhibits a trapezoidal distribution.

7: The optical particle detecting device as set forth in claim 1, wherein the light source is a light-emitting diode.

8: The optical particle detecting device as set forth in claim 7, wherein the light-emitting diode is provided with a light-emitting layer and a pad electrode disposed on top of the light-emitting layer, and
the length of the optical fiber is set so as to eliminate an image of the pad electrode in the beam that is emitted from an end portion of the optical fiber.

9: The optical particle detecting device as set forth in claim 1, further comprising:
a scattered light detecting portion that detects light scattered from a particle.

10: The optical particle detecting device as set forth in claim 1, further comprising:
a fluorescent light detecting portion that detects fluorescent light emitted from a particle illuminated by the light.

11: The optical particle detecting device as set forth in claim 1, further comprising:
an emission-side collimating lens, disposed between the optical fiber and the emission-side condensing lens, that forms the light that is emitted from the end portion of the optical fiber into a collimated beam.

12: The optical particle detecting device as set forth in claim 1, further comprising:
a detecting-side collimating lens that forms the light that is cut across by the airstream into a collimated beam.

13: The optical particle detecting device as set forth in claim 1, further comprising:
a detecting-side condensing lens that condenses the light that is cut across by the airstream.

14: A particle detecting method comprising:
emitting light from a light source;
an optical fiber carrying the emitted light;
condensing of the light emitted from an end portion of the optical fiber; and
an airstream including a particle cutting across the condensed beam.

15: The particle detecting method as set forth in claim 14, wherein
the optical fiber is a multimode optical fiber.

16: The particle detecting method as set forth in claim 14, wherein
the length of the optical fiber is set so that the optical flux in a cross-section of the beam that is emitted from the end portion of the optical fiber is distributed symmetrically about the center.

17: The particle detecting method as set forth in claim 16, wherein
the optical flux in the cross-section of the beam that is emitted from the fiber end portion exhibits a normal distribution.

18: The particle detecting method as set forth in claim 16, wherein
the optical flux in the cross-section of the beam that is emitted from the fiber end portion exhibits a rectangular distribution.

19: The particle detecting method as set forth in claim 16, wherein
the optical flux in the cross-section of the beam that is emitted from the fiber end portion exhibits a trapezoidal distribution.

20: The particle detecting method as set forth in claim 14, wherein
the light source is a light-emitting diode.

21: The particle detecting method as set forth in claim 20, wherein
the light-emitting diode is provided with a light-emitting layer and a pad electrode disposed on top of the light-emitting layer, and
the length of the optical fiber is set so as to eliminate an image of the pad electrode in the beam that is emitted from an end portion of the optical fiber.

22: The particle detecting method as set forth in claim 14, further comprising:
detecting light scattered from a particle.

23: The particle detecting method as set forth in claim 14, further comprising:
detecting fluorescent light emitted from a particle illuminated by the light.

24: The particle detecting method as set forth in claim 14, further comprising:
collimating the light emitted from an end portion of the optical fiber into a collimated beam, prior to condensing of the light emitted from an end portion of the optical fiber.
